(19) United States
(12) Patent Application Publication
(10) Pub. No.: US 2020/0298191 A1
(43) Pub. Date: Sep. 24, 2020

(54) VOLUMETRIC AND GRAVIMETRIC FILL LEVEL FOR PRODUCING A GAS MIXTURE

(71) Applicant: LINDE AKTIENGESELLSCHAFT, Munich (DE)

(72) Inventor: Hans Juergen SCHMID, Gröbenzell (DE)

(73) Assignee: Linde Aktiengesellschaft, Munich (DE)

(21) Appl. No.: 16/089,185

(22) PCT Filed: Mar. 14, 2017
(86) PCT No.: PCT/EP2017/025048

§ 371 Date: Sep. 27, 2018

(30) Foreign Application Priority Data
Mar. 31, 2016 (DE) 10 2016 003 875.6

(51) Int. Cl. B01F 13/10; G01L 19/00; G05D 11/13; B01F 3/02; B01F 15/00; F17C 5/06; F17C 5/00

(52) U.S. Cl. CPC B01F 13/1055; G01L 19/0092; G05D 11/132; B01F 3/026; B01F 15/00149; B01F 15/00357; F17C 2250/0626; F17C 5/007; F17C 2221/014; F17C 2221/011; F17C 2221/017; F17C 2227/04; F17C 2250/0426; F17C 5/06

(57) ABSTRACT

A method for producing a gas mixture in a gas container is provided, having a plurality of components. At least one first component is volumetrically metered, said first component being locked into at least one sample volume of a plurality of sample volumes from a storage container of the first component and conducted into the gas container from the at least one sample volume, and at least one second component is gravimetrically metered, wherein the at least one second component is conducted from a storage container of the at least one second component into the gas container, and the gas container is weighed using a scale in order to determine the content of the at least one second component. A device for carrying out the method is also provided.

The invention relates to a method and a device for producing a gas mixture out of a plurality of components.

The gravimetric method or manometric method is often used for producing gas mixtures.

In the gravimetric method, the individual components of the gas mixture to be produced are filled one after the other into the container (e.g., a pressurized gas cylinder), wherein the mass of the container and its contents are determined during or after each metering process by weighing the container. This yields the mass fractions of the individually poured in components, which can be converted into substance amount fractions.

If the desired accuracy cannot be achieved by directly metering the components in this way, e.g., at lower concentrations of in particular lighter components of the gas mixture to be produced, so-called pre-mixtures can be used, which contain the desired components with higher contents.

Further used for producing gas mixtures is the so-called volumetric method, in which a volume flow of the component to be metered is locked into a known sample volume, and transferred from the latter into the container.

Finally, use is also made of the so-called manometric method, for example as described in DE 197 04 868 C1. The pressure change in the container after it has been filled with the respective component is then measured for metering purposes.

The problem routinely encountered during the direct production of precise gas mixtures ranging from approx. 1 ppm to 1% v/v of at least one component of the gas mixture is that, at the usual gas container volumes, e.g., ranging from one liter to 50 liters, the scale resolution (gravimetric method), Shunt forces of the supply line, lifting effects and other disturbance sources make it necessary to prepare dilution stages or pre-mixtures so that the gas mixture to be produced can be produced with the required accuracy.

Proceeding from the above, the object of the present invention is to provide a method and device for producing a gas mixture that has been improved with respect to the aforementioned problem.

This object is achieved by a method with the features in claim 1, as well as by a device with the features in claim 10.

Advantageous embodiments of the method according to the invention or the device according to the invention are indicated in the corresponding subclaims or described below.

Claim 1 provides a method for producing a gas mixture in a gas container, in particular in the form of a pressurized gas cylinder, in particular with a volume ranging from one liter to 50 liters, wherein the finished gas mixture has a plurality of components, wherein at least a first component is volumetrically metered, wherein said first component from a storage container of the first component is locked into at least one sample volume of a plurality of sample volumes, and conducted into the gas container from the at least one sample volume, and wherein at least one second component is gravimetrically metered, wherein the at least one second component is conducted from a storage container of the at least one second component into the gas container, and the gas container is weighed using a scale in order to determine the content of the at least one second component.

In principle, the components can consist of all gases that are to be constituents of the completely produced gas mixture, in particular of pure gases such as nitrogen, oxygen, CO₂, argon, helium or other noble gases. In addition, a component can also involve a gas mixture, which is here referred to as a pre-mixture and itself can consist of several components.

An embodiment of the method according to the invention provides that the second component be a residual gas component, which makes up the largest content of the produced gas mixture.

An embodiment of the method according to the invention further provides that the at least one first component make up a content of the produced gas mixture that is smaller than 5% v/v, preferably smaller than 1% v/v, preferably smaller than 0.1% v/v, preferably smaller than 0.01% v/v, preferably smaller than 0.001% v/v, preferably smaller than 0.0001% v/v, preferably smaller than 0.00001% v/v, preferably smaller than 0.000001% v/v.

An embodiment of the method according to the invention further provides that the volumetric metering of the at least one first component and/or the gravimetric metering of the at least one second component take place automatically.

An embodiment of the method according to the invention further provides that the at least one first component be conducted into the at least one sample volume by way of a first flow path as well as a pressure regulator arranged in the first flow path, so that the at least one first component in the at least one sample volume has a predefinable pressure.

An embodiment of the method according to the invention further provides that the at least one first component be conducted into the at least one sample volume by way of a multiport valve, which can be used to establish a flow connection between the flow path and the at least one sample volume.

An embodiment of the method according to the invention further provides that the at least one sample volume be selected from a plurality of sample volumes (e.g., four sample volumes), wherein in particular one of the sample volumes has the largest volume, and wherein the other sample volumes each have a volume corresponding to a constant fraction of the respective next largest sample volume.

An embodiment of the method according to the invention further provides that the at least one second component be conducted into the gas container by way of a second flow path as well as a second pressure regulator arranged in the second flow path, wherein the second pressure regulator is configured in particular to regulate the fill rate, i.e., the quantity of gas to be metered or the second component that flows into the gas container per unit of time.

In particular, the second pressure regulator is controlled by means of the aforesaid output signal in such a way that the pressure of the component to be introduced into the gas container is reduced once the desired quantity of said component has been reached in the gas container. In this way, the volume flow in the gas container is throttled in a defined manner once the target quantity has been reached, and the gas container can be locked precisely once the target quantity has been reached by means of a valve provided in the second flow path.

An embodiment of the method according to the invention further provides that the at least one first component be pressed into the gas container by part of the at least one second component (in particular residual gas) to be introduced into the gas container conducted over the first flow path. This advantageously enables a complete transfer of the volumes to be metered by a subsequent pushing by means of the residual gas or at least one second component via the sample volume in the gas container.

The object according to the invention is further achieved by a device for producing a gas mixture in a gas container having the features in claim 10. Based on the above, the device consists at least of the following: a plurality of storage containers for storing components of the gas mixture to be produced, a gas container for holding the gas mixture to be produced, a scale for gravimetrically metering components of the gas mixture, which is configured to weigh the gas container, a first flow path with which a flow connection can be established between the storage container for gravimetrically metering components of the gas mixture to be produced and the gas container, a plurality of sample volumes for volumetrically metering components of the gas mixture to be produced, which each can be flow-connected with the gas container, and a second flow path with which a flow connection can be established between the storage containers and the plurality of sample volumes.

An embodiment of the device according to the invention provides that the first flow path be guided over a first pressure regulator, so that a component to be volumetrically metered can be locked into the respective sample volume with a predefinable pressure.

An embodiment of the device according to the invention further provides that the sample volumes each be arranged parallel to the first flow path, wherein each sample volume can be flow-connected with the first flow path by way of multiport valve, wherein each multiport valve has a first state in which the respective sample volume is flow-connected with the flow path, in particular with an inlet as well as an outlet of the respective sample volume, and a second state in which the respective sample volume is locked and separated from the flow path (inlet and outlet of the respective sample volume are closed).

An embodiment of the invention further provides that the sample volumes vary in terms of their volume, wherein in particular one of the sample volumes has the largest volume, and wherein the other sample volumes each have a volume corresponding to a constant fraction of the respective next largest sample volume.

A second pressure regulator is preferably arranged in the second flow path, wherein the second pressure regulator is configured to be controlled by means of an output signal of the scale (see above).

As a result, the present invention enables an automatable filling of gas mixtures, wherein the inventive combination of a volumetric and gravimetric metering of gas components eliminates the need for the conventionally used pre-mixtures, thereby simplifying production of the gas mixture overall, since the components can now be directly mixed together. The ability to automate the generation of gas mixtures allows several such devices or filing lines to be operated simultaneously by one person. In addition, the present invention enables a higher reproducibility during the production of gas mixtures, as well as a certification of the produced gas mixture directly by the device.

Additional features and advantages of the method according to the invention and the device according to the invention will be explained based on an exemplary embodiment with reference to the figures. Shown on:

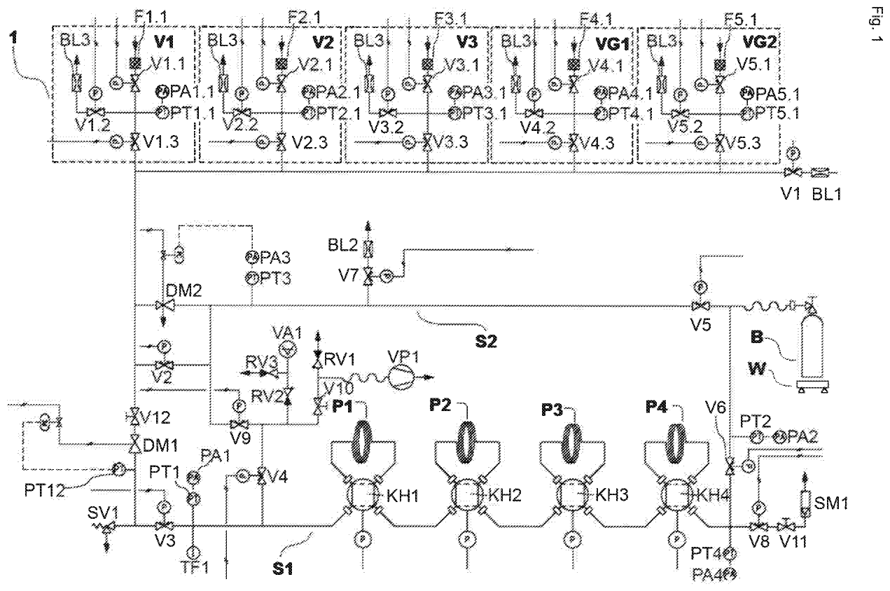

FIG. 1 is a structural design of a device according to the invention for implementing the method according to the invention and

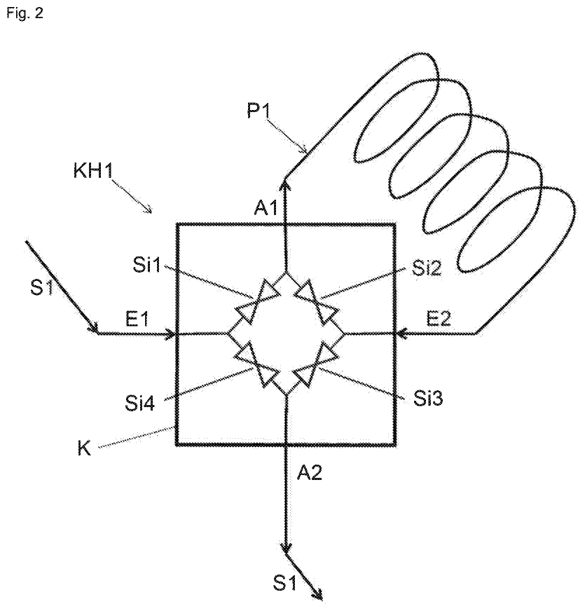

FIG. 2 is a schematic view of a multiport valve, which is preferably used for the device according to the invention or the method according to the invention.

FIG. 1 shows a device 1 for producing a gas mixture in a gas container B, which serves to hold the gas mixture to be produced. The gas container B is preferably a pressurized gas cylinder.

The device has a plurality of storage containers V1, V2, V3, VG1, VG2 or lines that serve to hold or store diverse components, which are to be mixed to yield the gas mixture to be produced. For example, argon can be stored in storage container V1, helium in storage container V2, and nitrogen in storage container V3. Furthermore, storage containers VG1 and VG2 can contain pre-mixtures, for example, which are to be used to produce a gas mixture.

For purposes of volumetrically metering the individual components, the individual storage containers V1, V2, V3, VG1, VG2 can be flow-connected with a series of sample volumes P1, P2, P3, P4 by way of a first flow path S1, which has a first pressure regulator DM1, so that the individual sample volumes P1, P2, P3, P4 can be filled with the respective component of the gas mixture to be produced at a predefined pressure ranging in particular from 0 to 20 bar, if necessary one after the other.

Specifically, a filter F1.1, F2.1, F3.1, F4.1, F5.1 along with two valves V1.1, V1.3; V2.1, V2.3; V3.1, V3.3; V4.1, V4.3; V5.1, V5.3 arranged one after the other can be used to establish a flow connection between each of the storage containers V1, V2, V3, VG1, VG2 and the first flow path S1 via the first pressure regulator DM1, and a second flow path S2 via a second pressure regulator DM2 described further below. Arranged between the two valves V1.1, V1.3; V2.1, V2.3; V3.1, V3.3; V4.1, V4.3; V5.1, V5.3 located downstream from the respective storage container V1, V2, V3, VG1, VG2 is a respective pressure sensor PT1.1, PT2.1, PT3.1, PT4.1, PT5.1, along with a branch to a respective additional valve V1.2, V2.2, V3.2, V4.2, V5.2 and a downstream aperture BL3. Arranged downstream from the valves V1.3, V2.3, V3.3, V4.3, V5.3 is a shutoff valve V12, which in turn is arranged upstream from the first pressure regulator DM1. The apertures BL3 are used to reduce a rinsing flow over the rinsing valves V1.2, V2.2, V3.2, V4.2, V5.2 in the event of a medium change (“double block and bleed”). When the valves V1.1, V2.1, V3.1, V4.1, V5.1 are closed, the tightness of these valves can be checked via a pressure rise of the respective pressure sensor PT1.1, PT2.1, PT3.1, PT4.1, PT5.1. For example, the sample volumes P1, P2, P3, P4 in the first flow path S1 can be designed as a loop, and differ in terms of their volume, wherein the volumes in the gas flow direction, i.e., toward the gas container B, diminish and each only measure a constant fraction of the previous volume, e.g., in the present case a fraction measuring 1/20. For example, the first sample volume P1 can have a volume of 2000 ml, the second sample volume P2 a volume of 100 ml, the third sample volume [P3] a volume of 5 ml, and the fourth sample volume P4 a volume of 0.25 ml.

The individual sample volumes P1, P2, P3, P4 are each connected with the first flow path S1 downstream from the first pressure regulator DM1 by way of a multiport valve KH1, KH2, KH3, KH4, wherein each multiport valve KH1, KH2, KH3, KH4 has a first state in which the respective sample volume P1, P2, P3, P4 is flow-connected with the first flow path S1 via a respective inlet and in particular by a respective outlet, as well as a second state in which the respective sample volume P1, P2, P3, P4 is completely locked and separated from the first flow path (S1). Accordingly, the sample volumes P1, P2, P3 and P4 can be separately charged with gas components at a variable pressure. This permits a precise volumetric metering of the respective component.

Provided downstream from the first pressure regulator DM1 as well as upstream from the multiport valves KH1, KH2, KH3, KH4 and downstream from the multiport valves KH1, KH2, KH3 and KH4 is a respective valve V3 or V6, which can be used to lock a section of the first flow path S1 in which the multipart valves KH1, KH2, KH3 and KH4 for sample volumes P1, P2, P3, P4 are arranged, wherein the volumetrically metered components can be guided out of the sample volumes P1 to P4 via the valve V6 into the gas container B. The valve V5 via which the second flow path S2 (see below) is guided to the gas container B is here closed.

The valve SV1 provided downstream from the first pressure regulator DM1 and upstream from the valve V3 is a safety valve. In the event the flow path S1 is configured for 30 bar in one example of the invention, SV1 would open at a pressure of above 30 bar (if DM1 allows passage).

A pressure and temperature sensor PT1 and TF1 are further provided downstream from the valve V3 as well as upstream from the multiport valve KH1 for measuring the pressure and temperature of the components to be metered into the sample volumes P1, P2, P3, P4. Another pressure sensor PT4 for measuring the pressure of the components to be volumetrically metered is provided upstream from the valve V6 as well as downstream from the multipart valve KH4. A pressure sensor PT2 is further provided for measuring the pressure in the gas container B downstream from the valve V6.

A branch to a valve V8 is further provided between the pressure sensor PT4 and the valve V6, through which the first flow path S1 can be rinsed. A needle valve or restrictor V11 is provided downstream from V8, and serves to limit the rinsing flow. A rotameter SM1 is further arranged downstream from the two valves V8 and V11.

Finally, a pump VP1 can be flow-connected with the sample volumes by valves V10 and V4 for evacuating the sample volumes P1, P2, P3, P4. The pump VP1 can further be flow-connected with the second flow path S2 by the valve V9.

The gas container B is further arranged on a scale W, so that components located in the storage containers V1, V2, V3, VG1 and VG2 can be gravimetrically metered into the gas container B. The content of the component in the finished gas mixture is determined by weighing the gas container B. The respective component to be gravimetrically metered is conducted out of the storage containers V1, V2, V3, VG1 and VG2 into the gas container B by the respective valves V1.1, V1.3; V2.1, V2.3; V3.1, V3.3; V4.1, V4.3; V5.1, V5.3 via the second pressure regulator DM2 of the second flow path S2, as well as by the valve V5.

In order to measure the pressure of the respective component in the second flow path S2, a pressure sensor PT3 is provided downstream from the pressure regulator DM2 as well as upstream from the valve V5. The scale W preferably provides an output signal, which is used to control the second pressure regulator DM2. As a result, the response of the scale W can be used to control gravimetric metering. For example, this enables a reduction in the fill rate upon reaching the respective target quantity in the gas container B.

Also provided in particular for evacuating the high-pressure side or second flow path S2 up to the valves V1.3, V2.3, is a valve V2, which is arranged parallel to the second pressure regulator DM2, so that evacuation need not take place via DM2.

Furthermore, a valve V7 branches from the second flow path S2 downstream from the second pressure regulator, wherein an aperture BL2 is arranged downstream from the valve so as to reduce a rinsing flow by way of the valve V7. Residual gas can be rinsed through V7 prior to transfer into the pressure container B. After filling is complete, the fill line to the connection valve of the pressure container B is under pressure. In order to close the gas container B, the pressure can be diminished by way of V7, so that the connection can be opened.

In the method according to the invention or the device according to the invention, small contents (e.g., ranging from 1 ppm to 1% v/v) are preferably volumetrically metered by way of the sample volumes P1, P2, P3 and P4, while larger contents are preferably metered gravimetrically. This holds true in particular for the residual gas, i.e., the component having the largest content in the gas mixture. In particular, the residual gas component can be used to press a previously volumetrically metered component out of one or several sample volumes P1, P2, P3, P4, specifically in cases where the pressure in the first flow path S1 or in the corresponding sample volumes P1, P2, P3, P4 is inadequate for transferring the component stored there in the gas container B. For this purpose, a partial flow of the residual gas component is conducted by the first pressure regulator DM1 into the first flow path S1, wherein the multiport valves KH1, KH2, KH3, KH4 of the respective sample volumes are set in such a way that the aforesaid residual gas portion takes the previously volumetrically metered component along into the gas container B.

The valves described above, in particular the valves KH1, KH2, KH3 and KH4 are preferably designed as multiport valves. The individual valves can further be pneumatically set.

Such multiport valves are preferably used, since they have an advantageously small design and low dead volume, and can be rinsed better or faster. This type of multipart valve with four ports, here in the form of two inputs E1, E2 and two outputs A1, A2, which are formed on a valve body K, is exemplarily shown on FIG. 2 based on the valve KH1 from FIG. 1. The multipart valve KH1 preferably has two membranes, each with two seats Sit, Sit or Si3, Si4, which are schematically depicted on FIG. 2 by one valve each. For example, depending on the setting of the membranes, gas can be conducted in a known manner out of the first flow path S1 by way of input E1 and output A1 into the sample volume P1 and stored there, or be removed from the sample volume P1 once again by way of the second input E2 and second input A2. It is likewise possible to relay gas via the sample volume P1 by way of the input E1 and output A2.

1. A method for producing a gas mixture in a gas container, which has a plurality of components, wherein at least one first component is volumetrically metered, wherein said first component from a storage container of the first component is locked into at least one sample volume of a plurality of sample volumes, and conducted into the gas container from the at least one sample volume, and wherein at least one second component is gravimetrically metered, wherein said second component is conducted from a storage container of the at least one second component into the gas container, and the gas container is weighed using a scale in order to determine the content of the at least one second component.

2. The method according to claim 2, characterized in that the second component is a residual gas component, which makes up the largest content of the produced gas mixture.

3. The method according to claim 1, characterized in that the at least one first component makes up a content of the produced gas mixture that is smaller than 5% v/v.

4. The method according to claim 1, characterized in that the volumetric metering of the at least one first component and/or the gravimetric metering of the at least one second component takes place automatically.

5. The method according to claim 1, characterized in that the at least one first component is conducted into the at least one sample volume by way of a first flow path as well as a pressure regulator arranged in the first flow path, wherein the at least one first component in the at least one sample volume has a predefinable pressure.

6. The method according to claim 1, characterized in that the at least one first component can be flow-connected by way of a multiport valve via the first flow path with the at least one sample volume, into which at least one sample volume is introduced.

7. The method according to claim 1, characterized in that the at least one sample volume is selected from a plurality of sample volumes, wherein one of the sample volumes has the largest volume, and wherein the other sample volumes each have a volume corresponding to a constant fraction of the respective next largest sample volume.

8. The method according to claim 1, characterized in that the at least one second component is conducted into the gas container by way of a second flow path as well as a second pressure regulator arranged in the second flow path, wherein the second pressure regulator is controlled by means of an output signal of the scale.

9. The method according to claim 1, characterized in that the at least one first component is pressed into the gas container by part of the at least one second component to be introduced into the gas container conducted over the first flow path.

10. A device for producing a gas mixture in a gas container, comprising:
a plurality of storage containers for storing components of the gas mixture to be produced,
a gas container for holding the gas mixture to be produced,
a scale for gravimetrically metering components of the gas mixture, which is configured to weigh the gas container,
a first flow path with which a flow connection can be established between the storage container for gravimetrically metering components of the gas mixture to be produced and the gas container,
a plurality of sample volumes for volumetrically metering components of the gas mixture to be produced, which each can be flow-connected with the gas container, and
a second flow path with which a flow connection can be established between the storage containers and the plurality of sample volumes.

11. The device according to claim 10, characterized in that a first pressure regulator is provided in the first flow path, wherein a component to be volumetrically metered can be locked into the respective sample volume with a predefinable pressure.

12. The device according to claim 10, characterized in that the sample volumes are each arranged parallel to the first flow path, wherein each sample volume can be flow-connected with the first flow path by way of multiport valve, wherein each multiport valve has a first state in which the respective sample volume is flow-connected with the first flow path, as well as a second state in which the respective sample volume is locked and separated from the first flow path.

13. The device according to claim 10, characterized in that the sample volumes vary in terms of their volume, wherein one of the sample volumes has the largest volume, and wherein the other sample volumes each have a volume corresponding to a constant fraction of the respective next largest sample volume

14. The device according to claim 10, characterized in that a second pressure regulator is arranged in the second flow path, wherein the second pressure regulator is configured to be controlled by means of an output signal of the scale.
